(19) United States
(12) Patent Application Publication
(10) Pub. No.: US 2006/0065277 A1
(43) Pub. Date: Mar. 30, 2006

(54) Dual tray athletic mouthguard

(76) Inventor: Scott Jacobs, Lakewood, CO (US)

Correspondence Address: Law Offices of John S. Munday, PO BOX 423, Isanti, MN, 55040, US

(21) Appl. No.: 10/955,030

(22) Filed: Sep. 29, 2004

(51) Int. Cl. A61C 5/14

(52) U.S. Cl. 128/861

(57) ABSTRACT

A mouthguard for use by athletes, including a dual tray assembly molded together. The first tray is molded from a hard plastic such as an ethylene vinyl acetate copolymer, and has a portion that engage the cusps of the lower jaw molars to prevent the tray from moving backward on impact. A second tray is molded on to the first tray using a soft plastic or gel like material, such as a high percentage vinyl acetate copolymers of ethylene vinyl acetate, that softens at slightly elevated temperatures that a user can easily tolerate. The first time the mouthguard is used, it is heated in warm water, then the user puts it in his or her mouth and bites down to cause the second tray to conform to the upper teeth. When in use, the ridges on the first tray engage the teeth of the lower jaw to prevent movement of the lower jaw on impact.

### BACKGROUND OF THE INVENTION

Current mouthpieces, such as athletic mouthguards, are usually formed from thermoplastic materials and come in a variety of shapes, designs, thicknesses, and sizes. Each is designed to protect a user's teeth against physical shock or blows either directly to the teeth, or against a user's jaws, head, or even the user's body. Such mouthpieces are also designed to ensure the mouthpiece stays in position and prevent bite through of the mouthpiece by the user either during normal use or upon the application of shock or blows. Such mouthpieces also may absorb, attenuate, or deflect such blows to decrease the resultant transmitted force in an attempt to decrease or minimize injury to the user.

A myriad of designs exist which attempt to reduce such injury. Such protection has been afforded by custom fitting and/or by the inclusion of ribs, bosses, chambers, inserts, devices, or by simply increasing the thickness of the mouthpiece thereby increasing its bulk. This increased bulk may also increase tongue and breathing interference with resultant discomfort to the user. Some such mouthpieces are composite designs which increase production costs and may lead to higher failure rates.

One mouthguard that attempts to protect against shock is disclosed in U.S. Pat. No. 5,339,832, in which a first softenable thermoplastic is shaped into an U-shape and a shock absorbing framework is imbedded in the posterior portion of the base of the mouthguard. The framework material has low compression and covers the front teeth. U.S. Pat. No. 5,636,379 also discloses a two component frame and resilient material mouthguard that is said to function as a jaw-joint protective device. U.S. Pat. No. 6,082,363 discloses a triple layer mouthguard with a base having an elastomeric frame embedded therein along with a liner that is softer and can conform to the user's teeth. All three designs have implanted frames that absorb impact.

My own patent, U.S. Pat. No. 5,732,715 discloses a mouthpiece formed from at least one sheet of resilient thermoplastic material having a quantity of generally spherically shaped gas pockets dispersed therein. The gas pockets in the sheet of resilient thermoplastic material are formed by a blowing agent. The preferred resilient thermoplastic material is ethylene vinyl acetate and the preferred blowing agent is p,p′-oxybis (benzenesulfonyl hydrazide). This has been effective as a safety mouthguard and has achieved good commercial success.

In some instances, the mouthguard can be fitted to the individual, such as by use of a thermoplastic that softens in a warm environment such as a warm water bath, so that it conforms to the shape of the specific user's jaw or teeth. While this is a benefit, such thermoplastics are not always adequately resistant to impact and do not always absorb all the force of a hard blow to the face or jaw, as might accidentally happen in athletic competition.

Accordingly, it is an advantage of the present invention to provide a mouthguard that is conformable to the user's jaw or teeth.

Another advantage of the present invention is to provide a mouthguard that does not move with respect to the teeth and lower jaw, so that the lower jaw does not move backward on impact, thus preventing injuries such as brain concussions.

Other advantages will appear hereinafter.

### SUMMARY OF THE INVENTION

It has now been discovered that the above and other objects of the present invention may be accomplished in the following manner. Specifically, the present invention provides a mouthguard that is a dual tray mouthguard for athletic uses.

A first tray is provided to give structural integrity that does not deform when impacted during use. A hard form of a synthetic such as a plastic is preferred. Materials such as certain grades of an ethylene vinyl acetate copolymer (known as EVA) are the preferred materials for the first tray. The bottom occlusal surface of the first tray includes at least one ridge on each side, and preferably a plurality of three or more ridges, that are positioned to engage the cusps of the lower jaw's molar teeth and prevent the lower jaw from moving. When the ridges engage the teeth, such as the cusps at the lower jaw molars, the lower jaw cannot move backwards. The possibility of severe impact to the lower jaw causing the lower jaw mandible to transfer impact to the brain and cause a concussion has been significantly eliminated.

A second tray is molded on to the first tray from a soft material, such as an ethylene vinyl acetate copolymer with a higher vinyl acetate component and is formed in a shape to contact the upper teeth of the user. This second material should have a softening temperature that is comfortable for the user, where the user can bite on the device after heating to that temperature, in hot water for example, to conform the second tray to the upper teeth.

### BRIEF DESCRIPTION OF THE DRAWINGS

For a more complete understanding of the invention, reference is hereby made to the drawings, in which:

FIG. 1 is a plan view of the bottom of the preferred embodiment of the present invention;

FIG. 2 is a sectional view taken along line A-A in FIG. 1; and

FIG. 3 is a side elevational view of the device shown in FIG. 1.

### DETAILED DESCRIPTION OF THE INVENTION

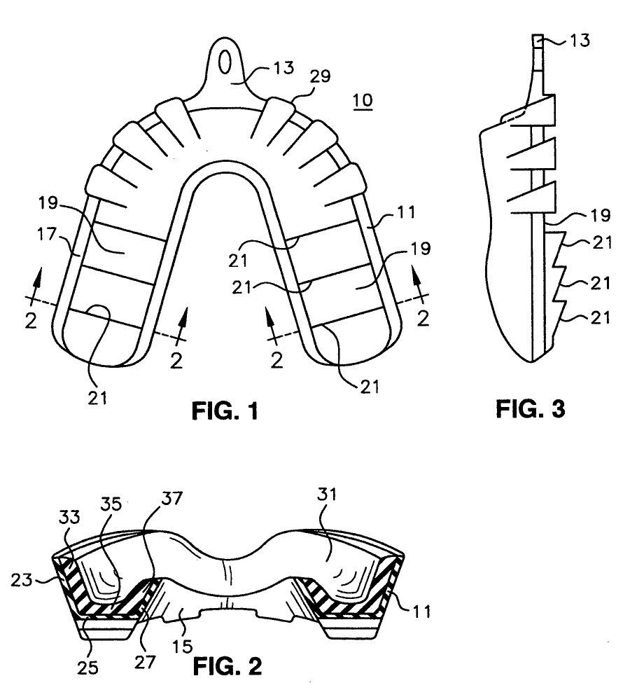

As shown in the drawings, a mouthguard in accordance with the invention, generally shown as 10, includes a first or outer tray 11, shown from the bottom in FIG. 1. First tray 11 has a tab or lip 13 for attachment to a cord or string, not shown, that can be worn around the user's neck in the conventional manner. Tray 11 has an upward facing generally U-shape such that the middle 15 of the U-shape is aligned with the front teeth and the ends 17 of the U-shape are each aligned with the back teeth. The bottom portion 19 of tray 11 along the two ends 17 includes at least one interface, shown in the drawings as ridge 21 formed on each end of sufficient size to engage at least one cusp of a lower molar of the user. The interface may be a ridge as shown, or a groove that permits the cusps on the molar to be engaged as described below. The term “interface” is defined as any raised or lowered portion of the bottom 19 that allows the cusps of the molars to engage in a manner that prevents the tray, and thus the lower jaw, from moving backward. Forward movement is not precluded. FIG. 2 illustrates the U-shape 23, 25 and 27.

The U-shape is constructed to fit the mouth of a user and engage the lower teeth. Tray 11 is of sufficient rigidity to prevent movement thereof with respect to the user's teeth upon impact, because ridges 21 engage the cusps of the molars and prevent the tray 11 from causing the mandible or lower jaw from moving back further into the mouth upon any impact to the mouth. The front 29 of the tray 11 therefore does not move. The present invention takes advantage of an instinctive reaction that a person often has, in that the person, upon anticipating a collision or other impact, will clench his or her jaw, clamping the teeth together. This instinctive reflex cooperates with the interface to further protect against backward lower jaw movement.

Fixedly attached to tray 11 is a second tray 31 that is positioned inside the U-shape 23, 25 and 27, and tray 31 also is generally U-shaped 33, 35 and 37. Second tray 31 is formed from a material having a softening point at a temperature low enough to not cause discomfort to the user, such that heating to that temperature and insertion into the user's mouth allows the user to conform said second tray 31 substantially to said upper teeth by biting down. Once the user has conformed the soft tray 31, he or she can continue to use the mouthguard without re-conforming it. In a preferred embodiment, the water will be heated to from about 130° F. to about 212° F., and preferably to between about 160° F. and 180° F., for about 30 to 60 seconds, more or less.

The first tray 11 has a thickness of about 1.0 to about 2.0 mm, and the preferred first tray 11 has a thickness of about 1.5 mm. The second tray 31 is thicker, and has a thickness of about 2.0 to about 4.0 mm, and the preferred second tray 31 has a thickness of about 3.0 mm. These dimensions have been found to provide a mouthguard that fit users comfortably without interfering with heavy breathing or swallowing saliva during use of the mouthguard.

First tray 11 is preferably molded by injection molding or other conventional thermoplastic processing techniques, such as through a central tab cavity that forms tab 13. After molding first portion 11, it is placed in a second mold and that second mold is injected with a synthetic material that forms second tray 31. It is preferable to mold tray 11 first since it is harder, and then mold tray 31.

It is contemplated that the first tray 11 of this invention will use a synthetic material having properties like the first two copolymers in Table I below, namely a melt index below 20, and preferably below 7, and a hardness of at least 80 and preferably 90 on the Shore A scale. Similarly the second tray of this invention will have a melt index above about 40, and preferably above 50, and a hardness of no more than about 65 and preferably about 40 on the Shore A scale. Other synthetic materials having these properties are also contemplated for use herein, as long as the material is suitably compatible with health and safety requirements for use in the mouth of a human. Because the materials have different durometer of the same EVA family of plastics, they will have a tendency to stick together when over-molded because they are of the same family of plastics.

Preferred are ethylene vinyl acetate or EVA copolymers and are available from the DuPont Company under the trade name Elvax® ethylene vinyl acetate copolymer. Elvax® is a registered trademark of the DuPont Company. Preferred Elvax® copolymers are designated with a grade designation of Elvax® 40W and Elvax® 150. Presented below is a table showing some of the properties of the preferred materials.

TABLE I

| Elvax ® Grade | Vinyl Acetate | softening point | Shore A value. |
|---|---|---|---|
| 350 | 25% | 270° F. | 80 |
| 450 | 18% | 302° F. | 90 |
| 40W | 40% | 220° F. | 40 |
| 150W | 33% | 230° F. | 65 |

Upon initial use, the mouthpiece is heated, preferably in warm water, to soften the first portion of the mouthpiece. The heated mouthpiece is quickly placed onto a user's teeth, again preferably against the upper teeth. The user applies suction between the jaw and mouthpiece to remove the excess moisture and air from between the mouthpiece and the teeth while gently biting down to form teeth indentations on the first portion (inner tray) of the mouthpiece, thus personalizing it to the user's specific needs. Once the mouthpiece cools, the teeth indentations remain, creating a custom fitting mouthpiece.

While particular embodiments of the present invention have been illustrated and described, it is not intended to limit the invention, except as defined by the following claims.

1. A mouthguard device for use by athletes in competition and the like, comprising:
a first tray having an upward facing generally U-shape for insertion into a user's mouth such that the middle of the U-shape is aligned with the front teeth and the ends of the U=shape are aligned with the back teeth, said first tray having a lower surface with at least one interface formed on each of said ends and of sufficient size to engage at least one cusp of a lower molar of the user, said first tray being of sufficient rigidity to prevent movement thereof with respect to the user's teeth upon impact; and
a second tray fixedly attached to said first tray and positioned inside said U-shape for engagement with the user's upper teeth, said second tray being formed from a material having a softening point at a temperature low enough to not cause discomfort to the user, such that heating to said temperature and insertion into the user's mouth allows the user to conform said second tray substantially to said upper teeth.

2. The device of claim 1, wherein said first tray is molded and said second tray is molded on to said first tray to fixedly attach the trays together.

3. The device of claim 2, wherein first tray is molded from an ethylene vinyl acetate copolymer having a hardness of at least 80 on the Shore A scale and a softening temperature of no less than about 270° F.

4. The device of claim 3, wherein second tray is molded from an ethylene vinyl acetate copolymer having a hardness of no more than 65 on the Shore A scale and a softening temperature of no more than about 230° F.

5. The device of claim 4, wherein said first tray is about 1.0 to about 2.0 mm thick and said second tray is about 2.0 to about 4.0 mm thick.

6. The mouthguard of claim 1, wherein said lower surface of said first tray has at least three ridges formed on each of said ends of sufficient size to engage the cusps of the lower jaw molar of the user.

7. A mouthguard device for use by athletes in competition and the like, comprising:
first tray means for engaging the lower jaw of a user and having an upward facing generally U-shape for insertion into a user's mouth such that the middle of the U-shape is aligned with the front teeth and the ends of the U-shape are aligned with the back teeth, said first tray means having a lower surface with at least one interface means formed on each of said ends and of sufficient size for engaging at least one cusp of a lower molar of the user, said first tray means being of sufficient rigidity to prevent movement thereof with respect to the user's teeth upon impact; and
second tray means for engagement of the user's upper teeth and fixedly attached to said first tray means and positioned inside said U-shape for said engagement with the user's upper teeth, said second tray means being formed from a material having a softening point at a temperature low enough to not cause discomfort to the user, such that heating to said temperature and insertion into the user's mouth allows the user to conform said second tray means substantially to said upper teeth.

8. The device of claim 7, wherein said first tray means is molded and said second tray means is molded on to said first tray means to fixedly attach the tray means together.

9. The device of claim 8, wherein first tray means is molded from an ethylene vinyl acetate copolymer having a hardness of at least 80 on the Shore A scale and a softening temperature of no less than about 270° F.

10. The device of claim 2, wherein first tray means is molded from an ethylene vinyl acetate copolymer having a hardness of at least 80 on the Shore A scale and a softening temperature of no more than about 230° F.

11. The mouthguard of claim 10, wherein said second portion means is formed from a gel selected from the group consisting of styrene block copolymers and thermoplastic polyurethanes.

12. The device of claim 11, wherein second tray means is molded from an ethylene vinyl acetate copolymer having a hardness of no more than 65 on the Shore A scale and a softening temperature of no more than about 230° F.

13. The device of claim 12, wherein said first tray means is about 1.0 to about 2.0 mm thick and said second tray means is about 2.0 to about 4.0 mm thick.

14. The mouthguard of claim 7, wherein said lower surface of said first tray means has at least three ridge means formed on each of said ends of sufficient size to engage the cusps of the lower jaw molar of the user.
